(19) United States
(12) Patent Application Publication
(10) Pub. No.: US 2013/0294751 A1
(43) Pub. Date: Nov. 7, 2013

(54) Method and Computer-Readable Medium for Creating and Editing Video Package Using Mobile Communications Device

(71) Applicant: Toshitsugu MAEDA, Tokyo (JP)

(72) Inventor: Toshitsugu MAEDA, Tokyo (JP)

(21) Appl. No.: 13/887,311

(22) Filed: May 4, 2013

Related U.S. Application Data
(60) Provisional application No. 61/643,716, filed on May 7, 2012.

(51) Int. Cl. H04N 9/87

(52) U.S. Cl. CPC H04N 9/87
USPC 386/282

(57) ABSTRACT

A computer-readable medium stores a non-transitory computer program for creating and editing a short video package using a mobile communications device provided with a memory and an interface. The program is configured to be stored in the memory; allow a user to select a template for the short video package via the interface among templates whose data are stored in the memory; save in the memory image data in a preset number of video clips each having a preset length according to the selected template; arrange the saved video clips in preset sequence; save in the memory audio/text data by the user synchronously with the video clips, respectively, according to the selected template; and include bibliographical information saved in the memory in a first and last video clips which are inserted before and after the video clips arranged in the preset sequence.

### CROSS-REFERENCE TO RELATED APPLICATIONS

This application claims the benefit of U.S. Provisional Application No. 61/643,716, filed May 7, 2012, the disclosure of which is herein incorporated by reference in its entirety.

### BACKGROUND

1. Field of the Invention

The present invention generally relates to a method for creating and editing a video package such as a video presentation and video report using a smartphone.

2. Description of the Related Art

In early 2000, filming, editing and airing video materials were complicated tasks that required professional help and equipment. Now, since video-making and publishing are easy, amateur videos permeate the internet on websites such as YouTube™, Vemio™, and NicoNico Video™. However, most amateur videos on the internet tend to be boring, shaky, clumsy, amateurish, too long, etc. Shooting is made easy with the iPhone® and other smart phones/hand-held devices, and publishing is also made easy with YouTube™ and other video uploading websites. A problem is that editing is complicated, and takes time and requires software and experience. In view of the above, some embodiments of the present invention solve the above problems by providing a video-making application for smartphones, featuring an auto-editing function among others.

Any discussion of problems and solutions involved in the related art has been included in this disclosure solely for the purposes of providing a context for the present invention, and should not be taken as an admission that any or all of the discussion were known at the time the invention was made.

### SUMMARY

An object of some embodiments of the present invention is to allow smartphone users to create professional-looking short (e.g., about 15 seconds to about 60 seconds, typically about 30 seconds) video reports, without having to go through a tedious and complicated editing process. This can result in better quality videos on the internet, and ones which can also be ultimately more interesting to watch. In some embodiments, the videos are created as instructed in a template, which is determined in the beginning of the process, and users merely have to follow the instructions in order to end up with a simple yet professional-looking video. This base template controls the application.

In some embodiments, the instructions in the template may be limited for simplicity and design freedom. For example, the template may instruct the user to shoot a wide shot without explaining a fixed meaning of “wide shot”, apart from giving the user tips and advice concerning video-shooting, although the inexperienced user may not fully understand the concept of a wide shot. The template, however, makes the video look good, regardless of the experience and the knowledge of the user in the video-editing field. Due to simplicity of use and look, the user does not feel confused as to how to use the application. The user, who may have no experience with video-editing software, has to be able to figure out how the application works within minutes of downloading it. In some embodiments, the user interface and the creating process look simple and straight to the point, e.g., there are no detailed settings and no editing complexities, but there are many icons and images. Further, due to design freedom, although the user may use a template, the user does not feel limited. The application is a platform of creative expression, and thus, fixed rules should be eliminated so that inexperienced users can create excellent videos easily, and more experienced users can build upon what is suggested to them in a template. In some embodiments, there may be little or no text, and instead, icons may be used, unless resorting to text is absolutely necessary.

Some embodiments include at least one of the following features:

1) By using a template integrated in the application installed in a smartphone, videos are automatically edited. The template defines when the video starts and ends, eliminating the concept of a timeline (this function may be referred to as “template-guided auto-editing”).

2) What scene (e.g., wide view or close view) should be shot next is instructed on the screen of a smartphone. By following the instructions and pushing a button for recording, shooting can be accomplished (this function may be referred to as “wizard-assisted shooting”), particularly assisting inexperienced users to improve finished video quality.

3) When recording voiceovers, voiceover scripts are shown on the screen of a smartphone, enabling perfect voiceovers to be recorded on the videos.

4) The camera of a smartphone continuously records scenes as an option, and the user can “rewind” the record and use any segments of interest.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments, which are intended to illustrate and not to limit the invention. The drawings are greatly simplified for illustrative purposes and are not necessarily to scale. Further, in any of the drawings illustrating the disclosed embodiments, although tabs and/or buttons are provided for easy understanding, it is preferable to use icons representing the same.

FIG. 1 is a schematic view of an initial screen of a device according to an embodiment of the present invention.

FIG. 2 is a schematic view of a screen of a device, for selecting a template according to an embodiment of the present invention.

FIG. 3 is a schematic view of a screen of a device, for selecting a next template according to an embodiment of the present invention.

FIG. 4 is a schematic view of a screen of a device, for showing selections according to an embodiment of the present invention.

FIG. 5 is a schematic view illustrating a sequence of video clips according to an embodiment of the present invention.

FIG. 6 is a schematic view illustrating another sequence of video clips according to an embodiment of the present invention.

FIG. 7 is a schematic view illustrating a conventional sequence of video clips according to an embodiment of the present invention.

FIG. 8 is a schematic view illustrating a conventional sequence of video clips according to an embodiment of the present invention.

FIG. 9 is a schematic view illustrating a conventional sequence of video clips according to an embodiment of the present invention.

FIG. 10 is a schematic view of a screen of a device, for inputting bibliographical information according to an embodiment of the present invention.

FIG. 11 is a schematic view of a screen of a device, for writing a script according to an embodiment of the present invention.

FIG. 12 is a schematic view illustrating a user in use of a script according to an embodiment of the present invention.

FIG. 13 is a schematic view of a screen of a device, for confirming or arranging the sequence according to an embodiment of the present invention.

FIG. 14 is a schematic view of a screen of a device showing an example of a wide shot according to an embodiment of the present invention.

FIG. 15 is a schematic view of a screen of a device showing an example of a wide shot with messages according to an embodiment of the present invention.

FIG. 16 is a schematic view of a screen of a device when footage is complete according to an embodiment of the present invention.

FIG. 17 is a schematic view of a screen of a device showing options according to an embodiment of the present invention.

FIG. 18 is a schematic view of a series of videos in sequence according to an embodiment of the present invention.

FIG. 19 is a schematic view of screens including first and last clips according to an embodiment of the present invention.

FIG. 20 is a schematic view of videos whose sequence can be changed according to an embodiment of the present invention.

FIG. 21 is a schematic view of a screen of a device showing a teleprompter function according to an embodiment of the present invention.

FIG. 22 is a flowchart illustrating template-guided auto-editing according to an embodiment of the present invention.

FIG. 23 is a flowchart illustrating a script function according to an embodiment of the present invention.

FIG. 24 is a flowchart illustrating wizard-assisted recording according to an embodiment of the present invention.

FIG. 25 is a flowchart illustrating a continuous recording function according to an embodiment of the present invention.

FIG. 26 is a schematic diagram illustrating a structure of a device according to an embodiment of the present invention.

### DETAILED DESCRIPTION OF EMBODIMENTS

The disclosed embodiments include a method for creating and editing a short video package using a mobile communications device provided with a memory, an interface, and a program stored in the memory and configured to allow a user to select a template for the short video package through the interface among templates whose data are stored in the memory; save in the memory image data in a preset number of video clips each having a preset length according to the selected template; arrange the saved video clips in preset sequence; save in the memory audio/text data by the user synchronously with the video clips, respectively, according to the selected template; and include bibliographical information saved in the memory in a first and last clips which are before and after the video clips arranged in the preset sequence, said method comprising:
selecting a template for a short video package by a user via the interface;
inputting in the memory image data in multiple video clips, each having a preset length according to the selected template, via the interface by following instructions indicated on the interface, wherein the inputted video clips are arranged in preset sequence;
inputting in the memory audio/text data synchronously with the video clips, respectively, according to the selected template; and
inputting bibliographical information in the memory, wherein the information is indicated in a first and last clips which are before and after the video clips arranged in the preset sequence,
whereby the short video package comprised of the multiple video clips with the audio/text arranged in sequence is created using the mobile communications device and saved in the memory.

In some embodiments, the program is further configured to indicate, via the interface, instructions for the user to follow, wherein the method further comprises indicating instructions via the interface for the user to follow when the user inputs the image data by shooting videos using a camera included in the device, said instructions suggesting shooting close or wide views.

In some embodiments, the program is further configured to input script and indicate the script in the interface, wherein the method further comprises indicating, via the interface, script inputted by the user in advance, when the user inputs the audio data through the interface.

In some embodiments, the program is further configured to perform continuous recording (also referred to as “continuous preliminary recording” or simply as “pre-recording”) of image data without saving it in the memory except for the most recent footage of a preset length of time, when the recording is stopped, wherein the method further comprises continuously recording image data without saving it in the memory using a camera included in the device for a preset length of time for continuous recording when the user inputs the image data; and saving a preset length of the most recent footage in the memory when the user stops the continuous recording or when the preset length of time for the continuous recording elapses.

In some embodiments, the device is accessible to the internet, and data of the short video package are transmitted to others through the internet.

In some embodiments, the device is a smartphone. In some embodiments, the memory is included in a hard drive or is an external memory.

In some embodiments, the preset number of video clips is 4 to 7, each being about 3 seconds to about 5 seconds long. In some embodiments, the duration of the video package is about 20 seconds to about 40 seconds.

In some embodiments, the template is at least one selected from the group consisting of a template for the user talking, a template for a person other than the user talking, a template for both the user and another person talking, a template for on-the-spot broadcasting, a template for narration, and a template for showing subtitles. The templates used for template-guided recording (e.g., recording can be completed solely by following instructions in each template) can refer to “who”, “when”, “what”, “how”, “where”, etc. and any terms, symbols, and/or icons representing or related to these categories can be used in the templates.

The disclosed embodiments also include a computer-readable medium on which is stored a non-transitory computer program for creating and editing a short video package using a mobile communications device provided with a memory and an interface, wherein the program is any of the program disclosed herein. A skilled artisan in the art can readily produce the program in view of the present disclosure, as a matter of routine experimentation.

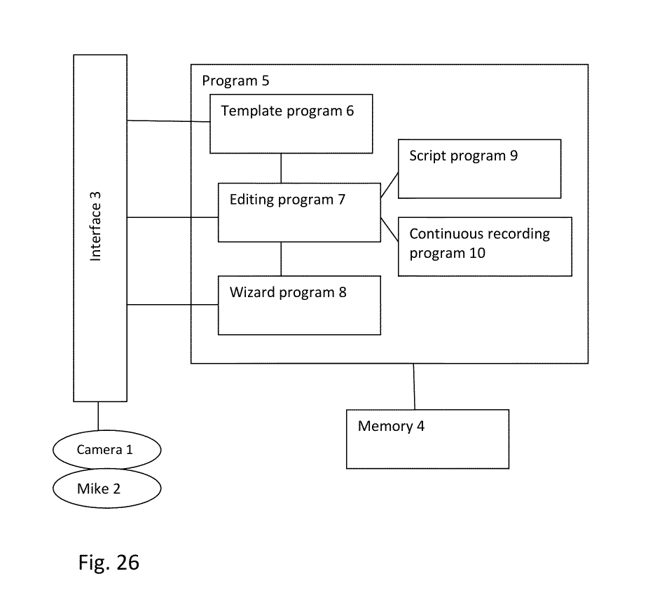

In some embodiments, as illustrated in FIG. 26, an application installed in a smartphone executes a program 5 which includes a template program 6 configured to allow a user to select a template for the short video package via an interface 3 among templates whose data are stored in a memory 4; an editing program 7 configured to save in the memory 4 image data in multiple video clips each having a preset length according to the selected template, arrange the video clips in a preset sequence, save in the memory 4 audio/text data synchronously with the video clips, respectively, according to the selected template, and indicate bibliographical information saved in the memory 4 in a first and last clips which are arranged before and after the video clips arranged in the preset sequence; and a wizard program 8 configured to indicate in the interface 3 instructions for the user when the user inputs the image data by shooting videos using a camera included in the smartphone (e.g., the instructions suggest shooting close or wide views). The editing program 7 may further include a script program 9 configured to input script and indicate the script in the interface 3 in advance when the user inputs the audio data via the interface 3. The editing program 7 may further include a continuous recording program 10 configured to perform continuous recording of images without saving data in the memory 3 for a preset length of time and save a preset length of the most recent footage of the image in the memory 3 when the continuous recording is stopped when either the user stops the continuous recording or the preset length of time for the continuous recording elapses. Image data can be captured using a camera 1 of the smartphone and audio data can be captured using a microphone 2 of the smartphone. Any other configurations of programs can be used, and a skilled artisan in the art can readily create programs necessary for performing the disclosed steps in view of the present disclosure including flowcharts as a routine work, depending on the operating system installed in the smartphone.

In this disclosure, “smartphone” refers to a mobile, wireless, digital communication device including, but not limited to, a personal handy-phone system (PHS), a cell phone with multiple functions, and any device equivalent thereto, including a personal digital assistant (PDA) such as iPhone®, iPad®, Android™, Symbian™, BlackBerry®, Windows Phone™, etc.

In this disclosure, any defined meanings do not necessarily exclude ordinary and customary meanings in some embodiments.

The present invention will be explained with respect to the disclosed embodiments which are not intended to limit the present invention.

Home Page

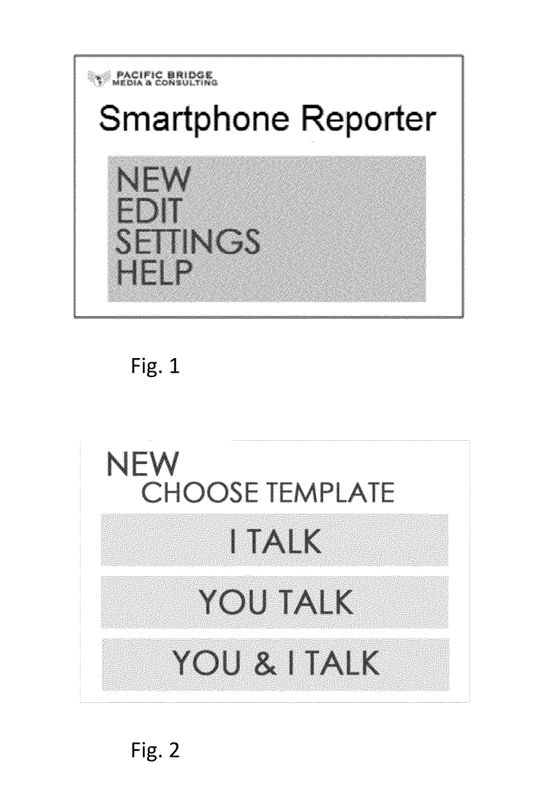

FIG. 1 illustrates a home screen of the application according to an embodiment. Any Logo can be placed instead of the words “Smartphone Reporter”. This page is the gate which welcomes the user. In this embodiment, there are only 4 buttons:

1) New: Allows the user to create a new video.

2) Edit: Allows the user to go to the video library to edit unfinished videos, share videos with friends, and delete any if needed.

3) Settings: Basic settings which can be changed if needed.

4) Help: Guidelines of the application, and video-making tips proposed by professional, experienced video journalists.

The application starts going through the video-making process with “New”.

New Page

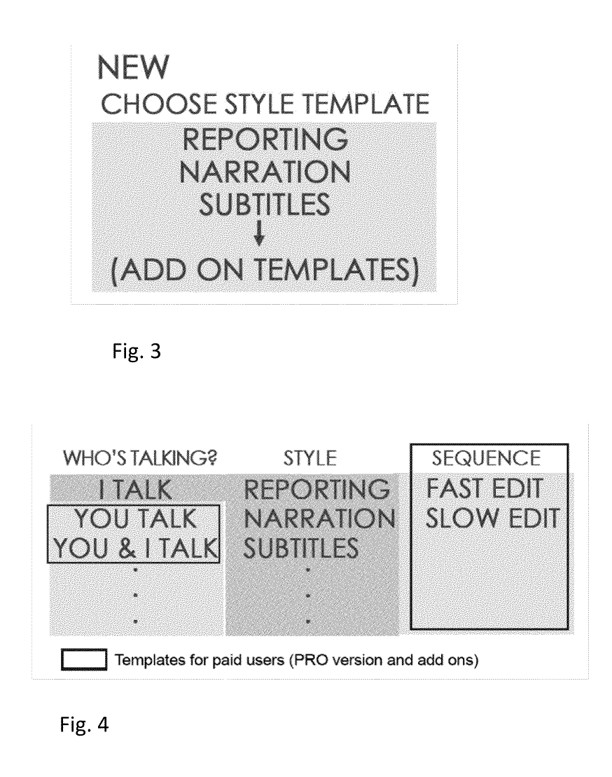

FIGS. 2 and 3 illustrate “New” pages according to an embodiment. This is the first step to making the video, and is also a place where the user chooses a template he or she wishes to use. FIG. 2 shows who is going to talk in the video (e.g. “I Talk”: The person holding the camera will talk in the video). FIG. 3 shows the presentation style templates (e.g. the type of video the user will produce). Once the user chooses who talks, he or she is able to chose the style.

In this embodiment, there are 3 major patterns for the “Who's talking” template: “I Talk”, “You Talk”, and “You & I talk”. The “I Talk” may be a complimentary version of the application, and the “You Talk” and “You & I Talk” templates may be available in paid versions of the application. Note that the template can also refer to “Who's speaking'?” and “I”, “You”, and “We” can be selected. Any other equivalent terms can be used.

1) “I Talk” Template

The “I Talk” template typically represents a reporting mode. When the “I Talk” template is chosen, as shown in FIG. 3, one of the following styles is then selected: a) “Reporting” to have the user shoot the videos and add a narration alone (i.e., the self-reporting style), b) “Narration” to have only a narration over the images, or c) “Subtitles” to have a subtitle scrolling at the bottom of the screen. The user can make a video alone, without the help of a second person. For example, the “I Talk” style is useful for reporting about an event or place, or for business or self-promotion.

2) “You Talk” Template

The “You Talk” template typically represents an interview mode. The user shoots the videos, but the reporting or narrating is done by another person. In this case, the user needs another person to complete the video. One of the styles shown in FIG. 3 also may be selected. For example, the “You Talk” style is useful for conducting an interview, or promoting other people's businesses or activities.

3) “You & I Talk” Template

This style combines the “I Talk” and “You Talk” templates. A part of the video is narrated by the user, and another part is an interview of another person. One of the styles shown in FIG. 3 also may be selected. For example, the “You & I Talk” style is useful for reporting about an event or a place, or promoting other people's businesses or activities.

Items for additional template styles may be available as add-ons as shown in FIG. 3. When another column is added to the screen shown in FIG. 4, the new column shows the “sequence templates”, for example, which are variations of the initial style templates (e.g. with differences of clip numbers and their durations). Most add-on templates are sequence templates (albeit with a few exceptions). The templates may be sorted out as illustrated in FIG. 4 according to an embodiment. The “I Talk” template may be free and the “You Talk”, “You & I Talk” templates and the sequence templates may be included in a paid version of the application. The user goes through the above steps to determine the format of the video. There may be various “sequence” templates for each “Style” template.

The following will explain the “Who's talking” template with the “I Talk” template, and the three style templates: “Reporting”, “Narration”, and “Subtitles”. However, a skilled artisan in the art can readily understand conditions and/or structures for practicing other templates, in view of the present disclosure, as a matter of routine experimentation.

Style Templates

In some embodiments, the following style templates are included as the default styles installed in the application. In some embodiments, there are three initial styles for the “I Talk” template: “Reporting”, “Narration”, and “Subtitles”. In these embodiments, each template is slightly different, as explained below.

1) “Reporting”: A combination of clips and the user's on-camera report. In some embodiments, it is made from six 3.5-second illustrative clips and 9 seconds of the user's on-camera report. The user is seen on the screen only during the 9 last seconds of the video, but his or her narration is heard throughout the entire video. Alternatively, other embodiments have four 5-second clips and a 10-second on-camera report for the “reporting” template. This may be determined following the practicability and feel of the first completed demo. In some embodiments, the number of clips may be 3 to 10 (typically 4 to 7), and the duration of clips may be about 2 seconds to about 15 seconds (typically about 3 seconds to 6 seconds), and the duration of the video package may be about 15 seconds to about 60 seconds (typically about 25 seconds to 40 seconds, most typically about 30 seconds).

2) “Narration”: A succession of illustrative clips with the user's voice narrating the story. In some embodiments, it is made from six 5-second illustrative clips.

3) “Subtitles”: Very similar to the “Narration” option. This is made from six 5-second clips, and the only difference is that instead of a narration, text appears at the bottom of the screen, explaining the story.

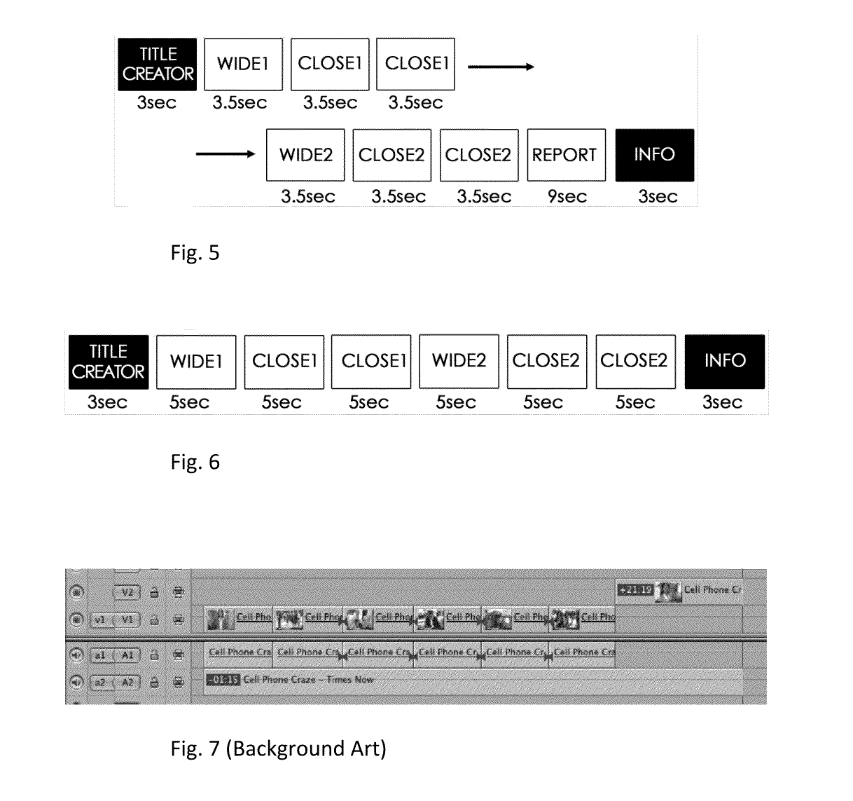

In some embodiments, additionally, 3 seconds of mostly black screen are added at the beginning and at the end of the video, regardless of which template is selected. The black screens show information such as the video title and its creator. FIG. 5 illustrates the sequence of each clip in the “Reporting” template according to an embodiment wherein the audio of the report is heard throughout the video, from WIDE1 to REPORT. FIG. 6 illustrates the sequence of each video in the “Narration” or “Subtitles” template according to an embodiment. The details regarding the indications “WIDE” and “CLOSE” will be explained later.

Final Cut Pro® as Reference

To further explain the concept, the features of the disclosed embodiments are compared with the timeline of Final Cut Pro® which is non-linear video editing software developed by Macromedia Inc. and Apple Inc. FIG. 7 illustrates the timeline of Final Cut Pro®. In Final Cut Pro®, there are 2 video channels (V1 and V2 on the top half of the screen) and 2 audio channels (A1 and A2 on the lower half of the screen). V1 is synchronized to A1, meaning the respective video and audio channels correspond to each other. The same can be said with V2 and A2.

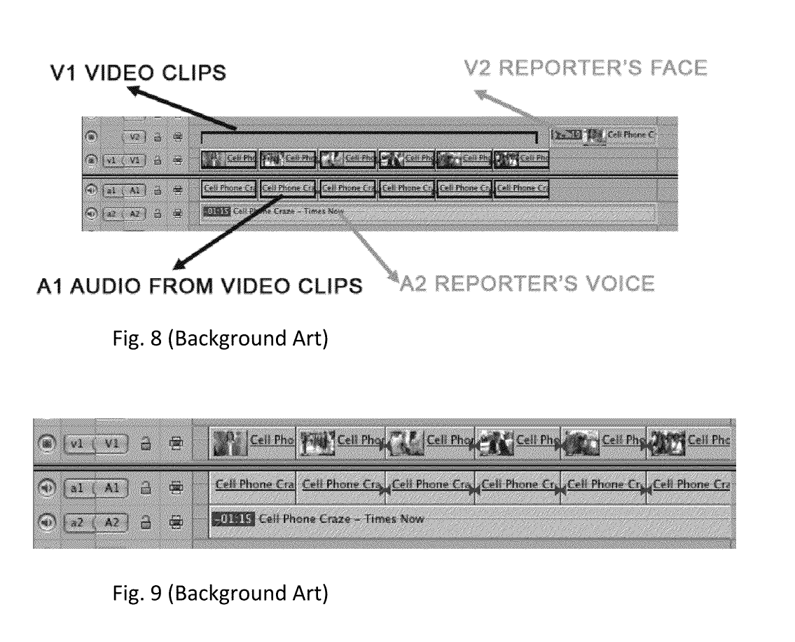

When the user selects “Reporting” and records the individual Video Clips (shown in black in FIG. 8) on the application, the user is recording the video clips on V1 and the audio on A1 simultaneously. Later, when the user records the Report (or “stand-up”; shown in gray), it is as if the user is recording V2 and A2 together, except, as can be seen on the visualization, the video for V2 will appear on screen only for the last several seconds. The audio A2, however, will be layered on the entirety of the video, including a period while V1 is showing in the final video. This eventually leads to another challenge of using audio from two separate channels (A1 and A2 in FIG. 8). If “Narration” is selected in the instant invention, the user will be doing essentially the same thing, following the same steps, but the difference will be that the user's face will not appear in the video. In other words, the face shot will NOT be integrated into the sequence, and thus, video does not have to be recorded while the user is talking to the camera. Only audio needs to be recorded. This will be the only instance where the user will be recording only the voice, and not his or her face. In Final Cut Pro, this would be visualized by the image illustrated in FIG. 9. Here again, A2 is the narration audio, and is layered during the whole video.

In some embodiments, in contrast, each clip integrally consisting of video and/or audio is not layered in the timeline. In an embodiment, the smartphone is capable of having stereo sound, and the audio from the two channels is kept on separate channels (right and left, like a stereo). The steps leading to the completion of any of the options discussed above are basically the same. After choosing the style template and the option, the user is first led to the main video-making page.

The Main Video-Making Page

This is where the user collects the elements he or she will need in order to make the video. As stated before, there is no editing involved in some embodiments, and the elements are automatically combined according to the template, and the user is, at the end, left with a high-quality video.

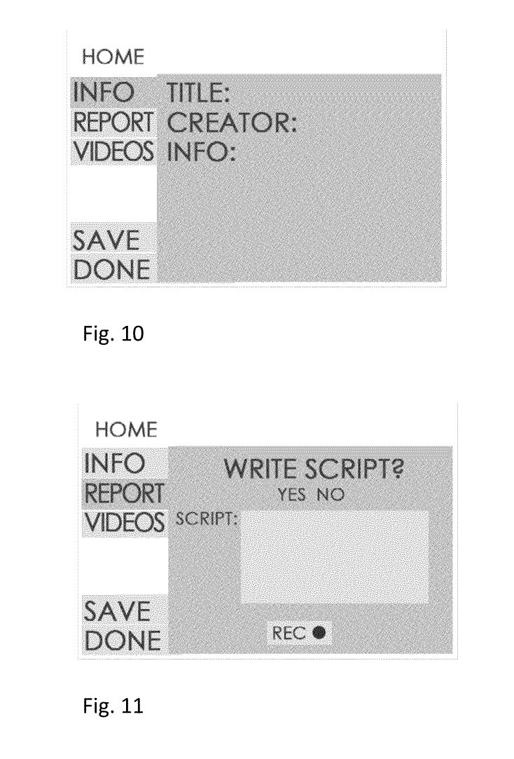

FIG. 10 illustrates the Main Video-Making Page according to an embodiment. On the left side of the screen in FIG. 10, five different tabs, for example, are provided. In FIG. 10, the tabs are written, but use of icons is preferable.

1) “Info”: The user types the information necessary to the video.

2) “Report”: The user records the report, narration, or types in the subtitles, depending on the option chosen at the beginning

3) “Videos”: The user shoots the visuals necessary to illustrate the video.

4) ‘Save“: The user saves the video, so that it is possible to go back later to finish it.

5) “Done”: This is the final step to check, render, and compress the video.

The only differing characteristics between the three styles (“Reporting”, “Narration” and “Subtitles”) reside in the “Report” function and the “Videos” function, which will be explained later.

The Info Tab

The user fills the necessary information about the video. For example:

a) The video Title.

b) The video Creator.

c) Other information which the creator can add optionally, such as website address, e-mail address, and more.

The Title and Creator information display during the 3-second black screen preceding the video. The other information displays during the 3-second black screen at the end of the video.

The Report Tab

This tab's function is one of the key elements to this application according to some embodiments, and is different depending on the style the user chooses. Each case will be individually explained below.

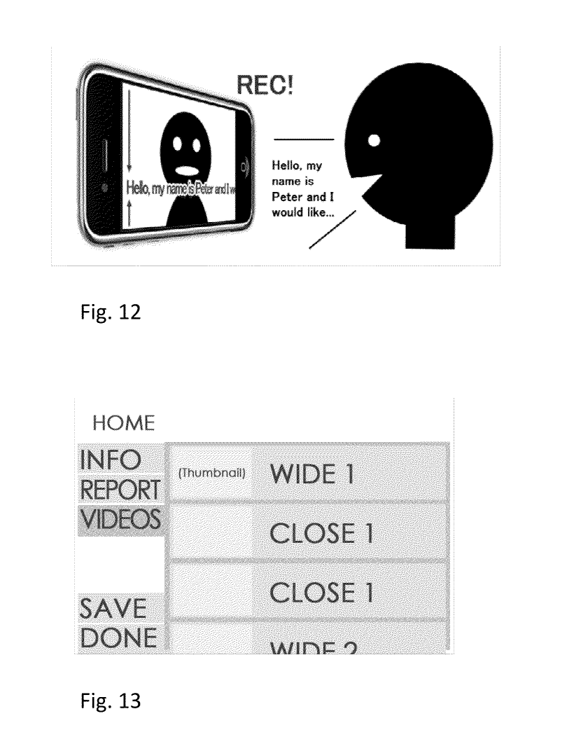

When the user chooses the “Reporting” option, the tab's function is to record the on-camera report of the user. The sound is used during the entirety of the 30-second video, but the visuals are used during the last 9 seconds on the video, for example. The user first decides if he or she would like to write a script before recording the report. If not, the user directly proceeds to record the report. If the user decides to write a script, a typing box appears as illustrated in FIG. 11. Once the script is written, the user proceeds to record the report. In some embodiments, during the recording, the written script scrolls on the screen, to help the user record smoothly, as illustrated in FIG. 12. An indicator on the screen near the camera gives the user the right timing to start speaking, so that it fits neatly into 30 seconds, and also to avoid the eye from wondering across the screen. Once the recording is over, the user can check the video, re-shoot it, or approve it.

When the user chooses the “Narration” option, the tab's function is to record only the voice of the user. The speaker's visuals do not appear in the “Narration” video. The basics are the same as for the “Reporting” option. The user can choose to write a script or not, and proceeds to record. The text scrolls on the screen if the user has chosen to write the script beforehand, and all he or she needs to do is to read it out aloud.

When the user chooses the “Subtitle” option, the process is even simpler than that for the “Narration” case. If the user chooses to write a script, it appears at the bottom of the screen in the final video. If the user chooses not to write a script, the video is narration/subtitle-less.

The Video Tab

This is one of the key features of the application in some embodiments, and the reason why “Video-editing” becomes so much easier. This tab's function is to collect the visual elements needed to create the video, called “illustrative clips”. The process is the same for each option, but there are some differences concerning the length of each video clip. The user collects six video clips for the end product, for example, regardless of which template he or she chooses. For example, each clip's length is:

i) 3.5 seconds long for the “Reporting” option (The remaining 9 seconds are filled by the on-camera report of the user). Alternatively, four 5-second clips and a 10-second on-camera report for the “Reporting” template can be provided. This is determined depending on the practicability and feel of the first completed demo.

ii) Five seconds long for the “Narration” and “Subtitles” options.

There is no complicated trimming or cutting process involved. When the application creates the final video, the clips are automatically connected, with a 0.2 second fade between each one of them, for example. When the assistant mode is “ON”, the user sees on the screen indications of what kind of clips to look for. These indications help an inexperienced user to shoot correct illustrative videos, which then connect in a natural way. In some embodiments, as illustrated in FIG. 13, the sequence of these indications is:

Wide1: Wide shot of element 1.

Close1: Close shot of element 1.

Close1: Close shot of element 1.

Wide2: Wide shot of element 2.

Close2: Close shot of element 2.

Close2: Close shot of element 2.

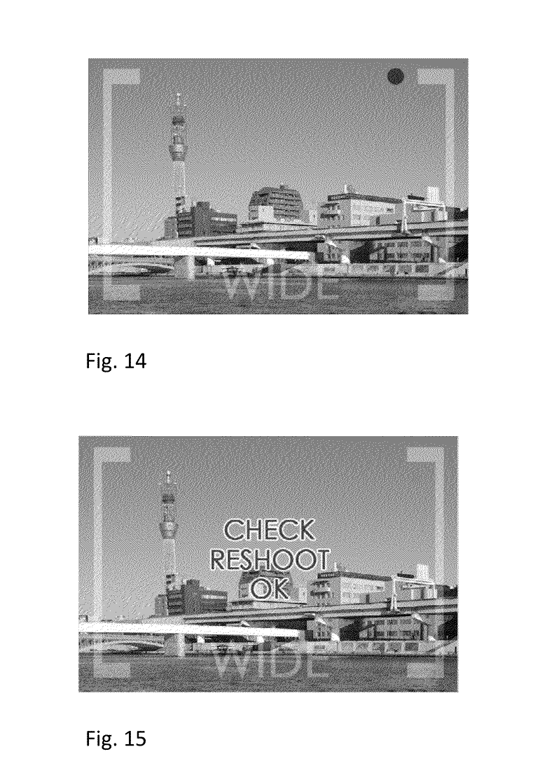

When the Assistant mode is “OFF”, the above indications do not show on the screen. When the user taps on each clip tab, the smartphone switches to a customized camera view like the one illustrated in FIG. 14, and the user can shoot. All the user needs to do is to direct the smartphone towards the object and let the camera record for the length of time needed. After shooting one video clip, the user has the choice to check, re-shoot, or approve it as illustrated in FIG. 15. If the user chooses OK, he or she is then led to shoot the next video. If the user does not wish to shoot the next video clip, he or she may be led back to the video tab.

In some embodiments, it is important to note that this is one of the most thorny aspects of this application which values freedom and creativity. An object is not to make users conform to a specific style or method of video creation. Some limitations concerning video/clip length are set so as to heighten the final product quality, but how users choose to shoot or frame their visuals should be entirely free, even when the users are assisted with the Assistant mode “ON”. It should not be too directive, yet still successfully guide the user through the various steps. Thus, it is preferable not to overemphasize the “Wide” and “Close” indications, and to use as many icons and visual indications as possible.

In some embodiments, the user must complete the tabs “Info”, “Report”, and “Videos” to create the video, but the sequence in which these are completed is entirely up to the user. This is to give the user more freedom as to how to construct the video. One may feel more comfortable writing the script first and shooting the visuals according to the script. On the other hand, one may want to structure the script according to the visuals he or she has collected. It may be a question of style or a question of circumstances.

The user can save the project at any time, by touching the “Save” tab.

The Done Tab

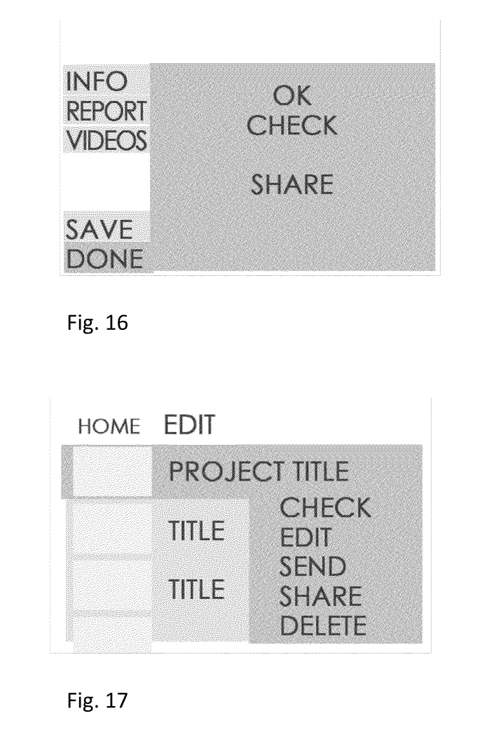

In some embodiments, the final step of creating the video. Preferably, the application automatically renders the video as the clips are shot, so that the end result can immediately be checked. However, if this is not the case, the user has to wait until the video is rendered by tapping the “OK” button as illustrated in FIG. 16. This saves the video at the same time.

One thing to keep in mind during development is to make the user wait as little as possible during loading or saving times. This is quite a challenge because of the complexity of the application, and the many functions it needs to have, and there are some limitations in the smartphone, which is not a high-speed computer. However, it should be noted that a skilled artisan would understand how to manipulate the processes in order to reduce the waiting time. Once the rendering is done, the user can watch and immediately share the video on social networking platforms such as YouTube™, Facebook™ and Twitter™ by touching the “Share” button.

Although this disclosure centers on the “I Talk” template, the entire video-making process can be mapped out readily by a skilled artisan based on this disclosure. For example, the “You Talk” and “We Talk” templates can be set to follow basically the same process as the “I Talk” template. In some embodiments, once the video is saved, the user can go back to it whenever needed by touching the “Edit” button on the “Welcome” page.

The Edit Page

In some embodiments, the Edit page is essentially the library of projects that have been saved by the user. All the saved projects are lined up, with the newest at the top. The user has the option to check, edit, send, share, or delete each video. “Checking” the video obviously lets the user see the video of his or her choice, so that this particular function does not require further detailed explanation. Thus, the other functions will be explained below, starting with “Edit”.

1) “Edit” a video: This is also quite straightforward. By touching “Edit”, the user is taken back to the main video-making page. The user has the option to make changes and save again.

2) “Send” a video: The user has the option to send a video to friends by email or SMS.

3) “Share” a video: Today no video-making is complete without the function to share it with friends or publish it to the internet. By touching “Share”, the user can upload the video to YouTube™, Facebook™, Twitter™, and other social network services. The user can choose the category to which the video belongs. Additionally, the application should be able to recognize and generate tags from the information typed in by the user when he or she made the video. Users have the option to type in additional tags. However, this is only a starting point, and in some embodiments, the videos can to be uploaded to a video website of the users' own and/or to individual websites also.

4) “Delete” a project: This also has a straightforward, obvious meaning. However, it should be noted that if a video has been saved on the smartphone hard drive or the like, the user can still retrieve it, even after the project has been deleted from the application.

The Settings Page

In some embodiments, too much setting-related complexity is avoided, but there is one setting that should preferably be integrated into the system, which relates to the “Assistant” mode. As described above, an object in some embodiments is to provide a user-friendly, simple, and creativity-inspiring application, while maintaining a certain level of quality. That can be achieved by the template format system disclosed herein with an “Assistant” mode, which instructs users, if desired, what kind of visuals they should shoot. However, considering that some users are not in need of such assistance, the “Assistant” can be turned on and off, depending on the user's video-making knowledge and experience. Upon downloading the application, the “Assistant” mode may be automatically set to “ON”, but users are free to set it to “OFF” if they wish. In some embodiments, the “Assistant” mode appears on the Welcome page.

The Help Page

In some embodiments, this takes users to the website of a company managing the application, where a wide variety of tips are provided to assist video-making

Modifications

In some embodiments, an object is to create an application which is intuitive and simple. The disclosed embodiments can simplify or navigate all aspects of video editing, which ordinarily requires technique and experience, so that even the beginner may enjoy the fun of video-making In some embodiments, some modifications as follows can be made to any of the disclosed embodiments:

1) Location input: Although this does not need to be integrated at the beginning, a location input system can be integrated in the application. An object is to create a map on a website, where visitors can see where each video has been created. In some embodiments, this can be accomplished much like Google™ does with pictures. This is important for business owners to promote their services.

2) Clips collected: In some embodiments, the collected visuals also can be saved in a separate library, depending on the memory capacity of the smartphone.

3) Final videos: In some embodiments, the final video also can be saved on a hard drive by creating a separate library where they can be stored.

4) Length of video clips for the “Reporting” template: As cited at various points in this disclosure, four 5-second clips and a 10-second on-camera report can be provided for the “Reporting” template, in place of 3.5-second clips which may unnecessarily complicate the video-making process. This may be determined depending on the practicability and feel of the first completed demo.

Add-Ons

In some embodiments, one of the application's biggest appeal is its customizable nature. With the possibility to add features, the user is able to endlessly customize features of the application and open up new possibilities. Moreover, the user is able to have an application that exactly suits his or her needs. The user simply needs to download an add-on update from a store and it is automatically incorporated into the software. Here is a list of optional add-ons:

1) Photo import function add-on: This function enables users to incorporate their favorite photos into the video. This may be useful when the user takes a great picture and would like to use it in the video.

2) Music function add-on: This function can give the user the means to import music from iTunes® and lay it onto the video. This can give a music-video style feeling to videos, and encourage users to employ the application for more entertainment and creative objectives. This may be useful when the user wants to use the application for entertainment purposes.

3) Stock footage function add-on: This add-on can address the fact that the user can only use footage he or she has shot for the current video being made. Users have the ability to shoot as many time-limited stock video clips as they want before creating a project. The user can pick and import these video clips to use in a project at will. This may be useful when the user wants to make a video consisting of clips shot and collected during a trip. Rather than starting a project at the beginning of the trip and adding clips as the trip progresses, the user can shoot a number of 5-second video clips and later choose the clips he or she would like to use in the video.

4) Video clip-swapping function add-on: The user can have the ability to change the order of the video clips when he or she is recording video on the video tab. This may be useful when the User would like to change the order of the video clips.

5) Different template add-ons: New and interesting templates can continuously be provided for the template library. There may be templates with video clips having a different lengths and others where the user's reporting clip may appear at a different portion of the video. This may be useful when the user wants to change the style of the video.

6) Freestyle template add-on: The freestyle template can offer a completely different video-making experience to users, giving them nearly unlimited editing freedom. Users are no longer tied to time-determined video clips, but are free to “start” and “stop” recording whenever they choose. The only limitation may be that the video cannot exceed 30 seconds, for example. This may be useful when the user is experienced enough to want to be in full control of the application.

7) Split-screen function add-on: This function can add the possibility for the reporter to report on-camera while showing pre-shot footage of the subject he or she is talking about. The video-making process is identical to the “Reporting” video creation, but the output is slightly different, as the reporter is on half of the screen during the entire run time, while the other half shows recorded video clips. This may be useful when giving quick updates on ongoing events.

8) Continuous recording function add-on (for breaking news and events): This add-on can address criticism that the application is not adapted to ongoing, breaking-news style video stories. As designed, the application is mainly adapted for planned, overview type stories, and not quick-action, episodic, or unfolding types of stories. With this function, the application can be constantly recording an event, until the user decides to stop recording. The application automatically keeps only the last 5 seconds of the video, for example. This may be useful when the user is at a soccer game, and does not know when there will be a goal. The user can keep recording until a team scores, and stop right after. The application can automatically retain the last 5 seconds, for example, which includes the goal.

In some embodiments, the application for creating and editing a video package using a smartphone can be achieved by performing the following six simple steps:

Step 1: Selecting a “who” or “what” template (i.e., a theme template/music) (FIG. 2);

Step 2: Selecting an output style template (FIG. 3);

Step 3: Shooting 4-7 clips (assisted by Wizard) (FIGS. 13-15);

Step 4: Reading out text to record voiceover/PTC (piece-to-camera) (optional) (FIGS. 11 and 12);

Step 5: Typing text information (FIG. 10);

Step 6: Completing the task (the application automatically finishes editing, rendering and uploading) (FIGS. 16 and 17).

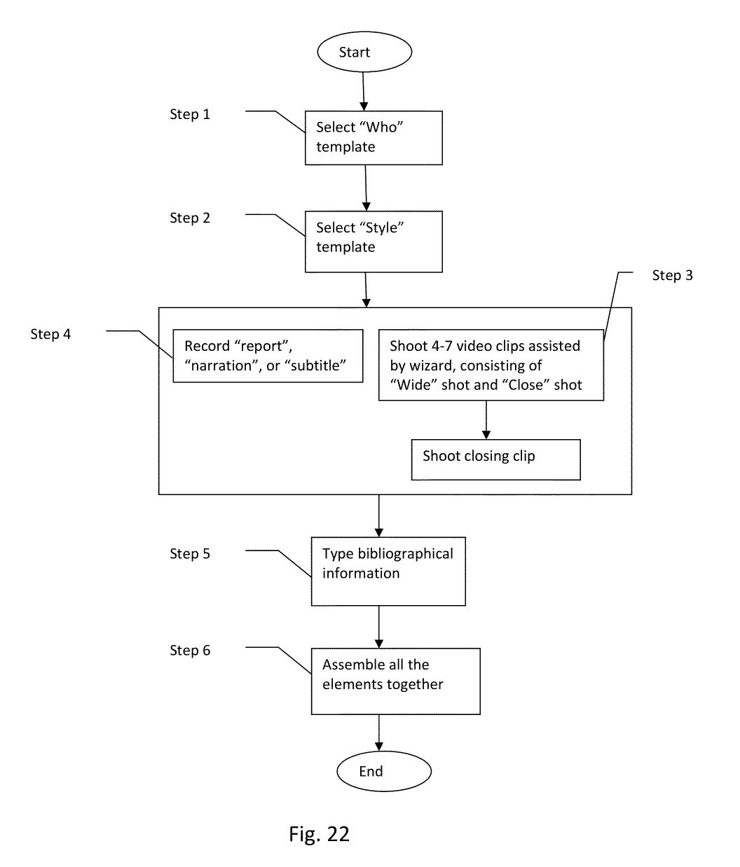

The above sequence is illustrated in FIG. 22. Typically, the all steps above may be accomplished within 5 to 10 minutes. The above sequence can be changed; for example, step 5 can be done before step 3, and step 4 can be done simultaneously with step 3 when the “report” template is selected. In some embodiments, typically, the steps are performed as follows. When this application starts, as illustrated in FIG. 22, in step 1, the user selects who talks: “I” (the user holding the smartphone), “You” (a person other than the user), or “You & I” (both people recording narration), by selecting the corresponding template. In step 2, the user selects what “style” of video is created: a “Report” video, “Narration” video, or “Subtitle” video, by selecting the corresponding template. The selected template guides the user to a main video-making page, and the user follows the template's instructions. In step 3, a number of clips are shot as instructed by the template. For example, an “I talk” and “Report” template may instruct the user to take the following videos: Wide shot of element 1 (3.5 sec)→close shot of element 1 (3.5 sec)→second close shot of element 1 (3.5 sec)→wide shot of element 2 (3.5 sec)→close shot of element 2 (3.5 sec)→second close shot of element 2 (3.5 sec). Next, in step 4, the template may instruct the user to record a 30-second-long report, with only the final 9 seconds being used in the final product (closing video), for example, where a single track for video and a single track for audio input are used, which are separated. In step 4, when the “narration” or “subtitle” template is selected, narrations or subtitles are recorded by following the template's instructions. In step 5, the template may instruct the user to type the title of the product, the name of the creator, other bibliographical information, for the first and last 3-second clips (previously mentioned black screens). In step 6, once everything is done, the application automatically assembles the elements according to the template selected. There is no need for time-consuming editing on a timeline, which also requires a certain level of knowledge about video editing. Once all elements are shot and recorded, the application automatically strings them together and the user achieves a simple but professional-looking video. The final product is illustrated in FIG. 5.

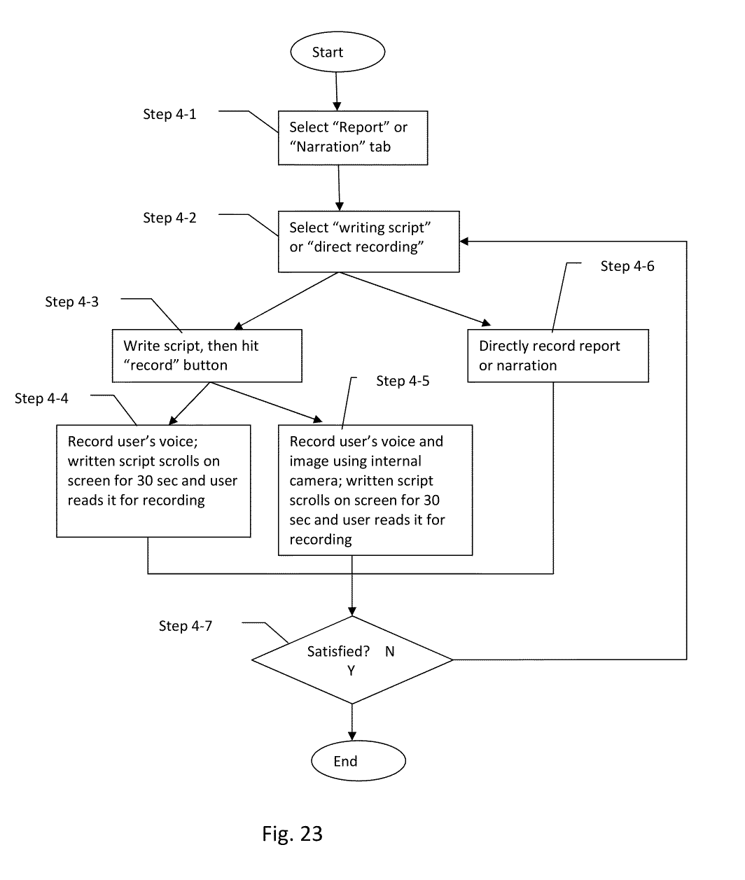

In step 4, a teleprompter function can be used as an option when the template for “I report” or “I narrate” is selected. As illustrated in FIG. 23, in some embodiments, on a main video-making page, the “Report” or “Narration” tab is selected in step 4-1 accordingly. In step 4-2, the user is presented the choice to either write a script or directly record video and voice. In step 4-3, the user who has selected writing a script writes a script and then hits a “record” button. In step 4-4, for the user who has selected the “Narration” tab, the written script scrolls on the screen for 30 seconds, for example, and the user reads it to record his/her voice as narration. Alternatively, in step 4-5, for the user who has selected the “Report” tab, the camera switches to internal camera, and records the user's voice and image. The written script scrolls on the screen for 30 seconds, for example, and the user reads it to record a report. Alternatively, in step 4-6, the user who has selected to directly record a report or narration records the report or narration without a script. Upon steps 4-4, 4-5, and 4-6, the user can review the recording, and in step 4-7, if the user is not satisfied with the recording, the user goes back to step 4-2 where the user selects writing script or directly recording a report or narration, and repeats the steps again. If the user is satisfied with the recording, this process ends, and the user goes back to the main Video-Making page to finish creating videos.

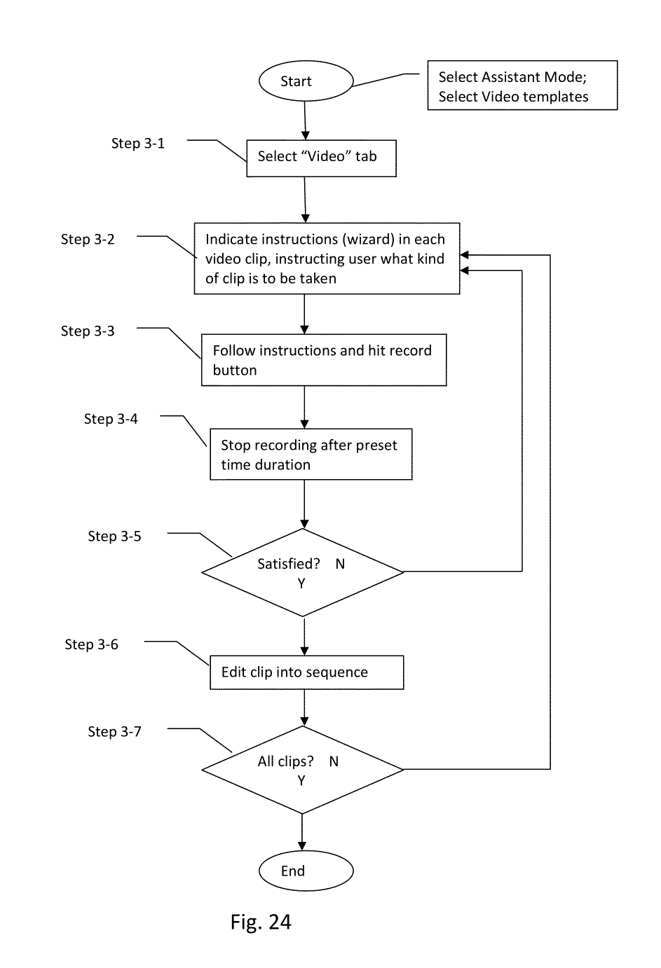

Returning to step 3, the user can use a wizard-assisted shooting feature. This feature is highly helpful, especially for inexperienced users. The user can select an assistant mode to use the feature on the setting screen before selecting video templates. Alternatively, the user can select the assistant mode on the Main Video-Making page after selecting video templates. In some embodiments, as illustrated in FIG. 24, in step 3-1, the user selects the “Video” tab on the Main Video-Making page, and then, in step 3-2, each video clip shows instructions (wizard) instructing the user what kind of clip is to be taken. For example, the instructions include a specific shooting instruction message such as “shoot wide shot of shop exterior” appearing on the screen. In step 3-3, the user follows the instructions and hits the Record button, starting recording accordingly. In step 3-4, recording automatically stops after a preset length of time elapses. In step 3-5, if the user is satisfied with the clip and accepts it, the clip is edited into sequence in step 3-6. If the user is not satisfied with the clip and does not accept it, the user goes back to step 3-2 and repeats the steps. In step 3-7, if all the clips are taken and satisfactory, and the sequence is complete, the wizard-assisted video shooting ends. If the sequence is not complete, the user goes back to step 3-2 and repeats the steps until the sequence is complete.

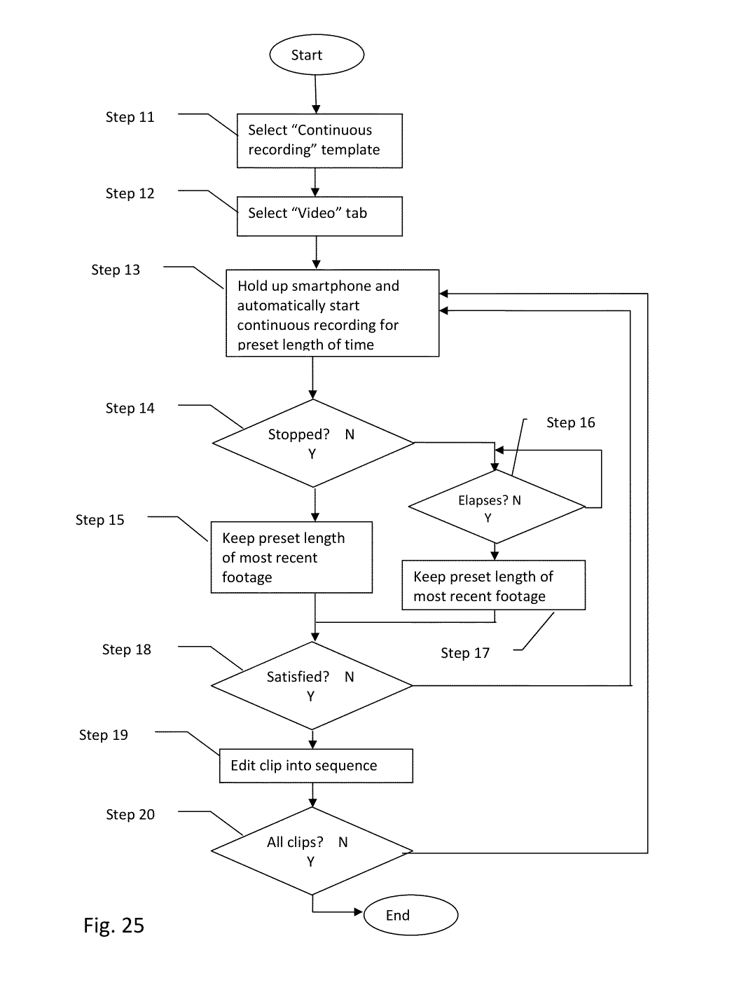

In step 3, alternatively, the user can use a continuous recording feature, wherein the user can use continuously recorded footage instead of shooting clips by following the wizard. In some embodiments, returning to step 2, the user selects a “Continuous recording” template as a template, leading to step 11 as illustrated in FIG. 25. In step 12, the user selects the “Video” tab on the Main Video-Making page. In step 13, the user goes to the video recording screen and holds up the smartphone without pressing the “Record” icon. The application automatically starts continuous recording for a preset length of time. In step 14, the user can stop the recording, and if the user stops the recording, the application keeps a preset length of the most recent footage and records it. In step 14, if the user does not stop, and thus, a preset length of time for continuous recording elapses in step 16, and then, in step 17, the application keeps a preset length of the most recent footage and records. In step 18, if the user is satisfied with the clip and accepts it, the clip is edited into sequence in step 19. If the user is not satisfied with the clip and does not accept it, the user goes back to step 13 and repeats the steps. In step 20, if all the clips are taken and satisfactory, and the sequence is complete, the application ends. If the sequence is not complete, the user goes back to step 13 and repeats the steps until the sequence is complete.

The following is an example illustrating modified embodiments. In step 1, a theme template that most fits a user's theme can be selected, such as:
News
Interview
Event
New product arrival/update
Freestyle, etc.

Each template comes with choices of matching background music.

In step 2, how the user wants to present his or her video is selected, such as:
Voiceover with piece-to-camera (Standup)
Voiceover without piece-to-camera
No voiceover; subtitles only

In step 3, a wizard is used for assisting shooting, in which <User>, <Subject>, and <Selected templates> are selected. For example, the following choices are made:

### <User>

Mr. Chuya Nakazawa

Chief of Living Environment Dept., at ITO EN, LTD

### <Subject>

Recycling tea leaves used to make beverages

### <Selected Templates>

Theme Template—New product update

Style template—Voiceover with PTC (piece-to-camera)

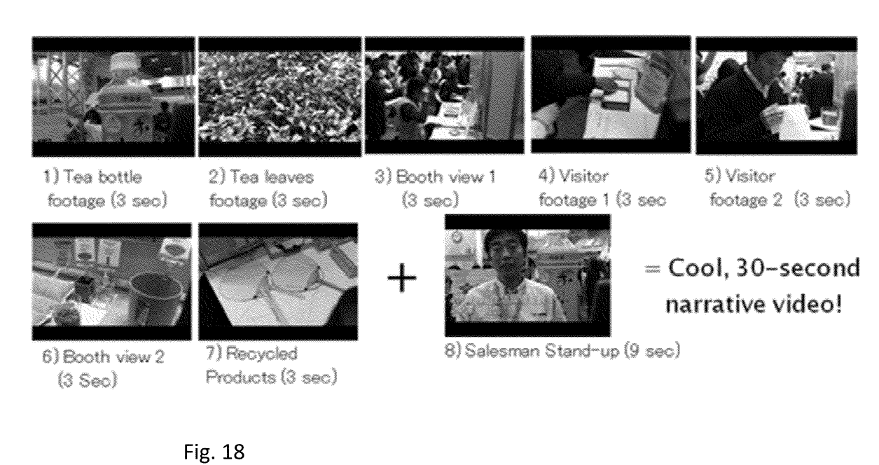

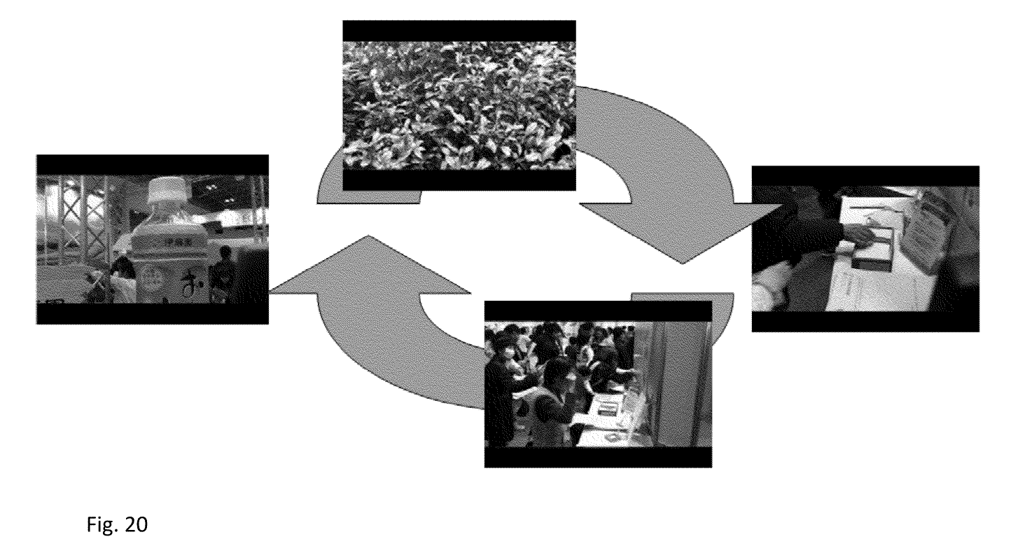

Video footage may consist of videos 1) to 8) in sequence illustrated in FIG. 18. In this example, the “I Talk” template and the “Reporting” template (FIGS. 1-3) are selected. In the “Reporting” template, in this example, seven 3-second videos 1 to 7 and one 9-second video 8 are used as compared with those in the sequences shown in FIGS. 5 and 6. The total length of the videos is 30 seconds. In this wizard, video clips 1 and 4 are instructed to be wide views, whereas video clips 2, 3, 5, 6, and 7 are instructed to be close views in a manner similar to that shown in FIGS. 13-15. However, in this example, video clips 1 and 3 are wide views, and video clips 2 and 4 to 7 are close views. This is because the user has changed the sequence of the videos by using the “Edit” tab in a manner shown in FIG. 17. The tab allows the user to choose the sequence of clips shown on the screen with a simple touch of the finger as shown in FIG. 20.

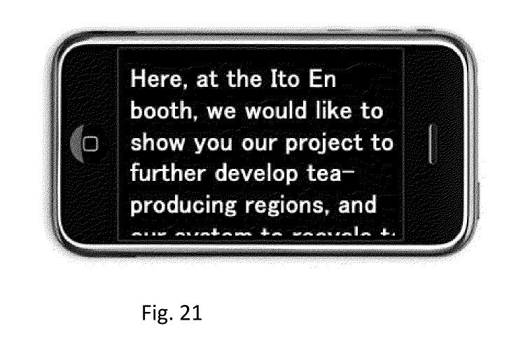

In step 4, the user talks in videos 1 to 7 and the person interviewed talks in video 8, and they can use voiceover scripts for recording as an option in a manner similar to that shown in FIGS. 11 and 12. In this example, the size of the voiceover script is limited to 150 characters in Japanese and 300 characters in English/other Western languages. The voiceover script may be as follows: “Here, at the Ito En booth, we would like to show you our project to further develop tea-producing regions, and our system to recycle tea-leaves used to produce our “Ooi Ocha!” brand . . . etc.” By hitting the “Rec” button and reading the script out, the user's voice and/or the presenter/character's voice are recorded and automatically edited into the video sequence. The voiceover script appears on the smartphone screen just like a teleprompter for broadcasters, as illustrated in FIG. 21. Although the “I Talk” template is selected, as long as the microphone built into the smartphone is used for recording, any person other than the user can speak. The videos are connected with a 0.2-second fade automatically.

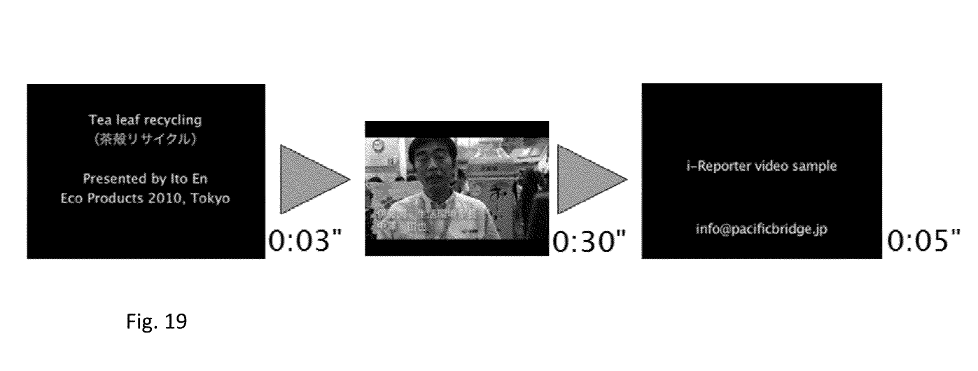

In step 5, the video title, creator, and store information/location are inserted in a manner shown in FIG. 10. In FIG. 10, the “Info” tab is the first tab on the screen. However, as in this example, the tab can be disposed after the “Videos” tab. As illustrated in FIG. 19, these texts are shown at the beginning (3 seconds) and the end (5 seconds) of the sequence in a manner shown in FIGS. 5 and 6.

In step 6, the video package can instantly and automatically be uploaded to the user's personal video collection or any location selected by the user including social network platforms such as YouTube™, Facebook™, and twitter™ so that friends and family can view them.

In the present disclosure where programs and/or structures are not specified, a skilled artisan in the art can readily provide such programs and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A method for creating and editing a short video package using a mobile communications device provided with a memory, an interface, and a program stored in the memory and configured to allow a user to select a template for the short video package through the interface among templates whose data are stored in the memory; save in the memory image data in a preset number of video clips, each having a preset length according to the selected template; arrange the saved video clips in preset sequence; save in the memory audio/text data by the user synchronously with the video clips, respectively, according to the selected template; and include bibliographical information saved in the memory in a first and last clips which are inserted before and after the video clips arranged in the preset sequence, said method comprising:
selecting a template for a short video package by a user through the interface;
inputting in the memory image data in multiple video clips, each having a preset length according to the selected template via the interface by following instructions indicated in the interface, wherein the inputted video clips are arranged in preset sequence;
inputting in the memory audio/text data synchronously with the video clips, respectively, according to the selected template; and
inputting bibliographical information in the memory, wherein the information is indicated in a first and last clips which are inserted before and after the video clips arranged in the preset sequence,
whereby the short video package comprised of the multiple video clips with the audio/text arranged in sequence is created using the mobile communications device and saved in the memory.

2. The method according to claim 1, wherein the program is further configured to indicate instructions for the user to follow in the interface, wherein the method further comprises indicating instructions for the user to follow in the interface when the user inputs the image data by shooting videos using a camera included in the device, said instructions including those for shooting close or wide views.

3. The method according to claim 1, wherein the program is further configured to input script and indicate the script in the interface, wherein the method further comprises indicating in the interface script inputted by the user in advance when the user inputs the audio data through the interface.

4. The method according to claim 1, wherein the program is further configured to perform continuous recording of image data for a preset length of time without saving data in the memory except for a preset length of the most recent footage when the continuous recording is stopped, wherein the method further comprises continuously recording image data using a camera included in the device for a preset length of time when the user inputs the image data; and saving a present length of the most recent footage of the image data in the memory when either the user stops the continuous recording or the preset length of time for the continuous recording elapses.

5. The method according to claim 1, wherein the device is accessible to the internet, and data of the short video package are uploaded to the internet or transmitted to others.

6. The method according to claim 1, wherein the device is a smartphone.

7. The method according to claim 1, wherein the preset number of video clips is 4 to 7, each being about 3 seconds to about 5 seconds long.

8. The method according to claim 1, wherein the duration of the video package is about 20 seconds to about 40 seconds.

9. The method according to claim 1, wherein the template is at least one selected from the group consisting of a template for the user speaking, a template for a person other than the user speaking, a template for both the user and another person speaking, a template for on-the-spot broadcasting, a template for narration, and a template for using subtitles.

10. The method according to claim 1, wherein the memory is an external memory.

11. A computer-readable medium on which is stored a non-transitory computer program for creating and editing a short video package using a mobile communications device provided with a memory and an interface, said program being configured to be stored in the memory; allow a user to select a template for the short video package via the interface among templates whose data are stored in the memory; save in the memory image data in a preset number of video clips, each having a preset length according to the selected template; arrange the saved video clips in preset sequence; save in the memory audio/text data by the user synchronously with the video clips, respectively, according to the selected template; and include bibliographical information saved in the memory in a first and last video clips which are inserted before and after the video clips arranged in the preset sequence, so that the device can (i) select a template for a short video package by a user via the interface; (ii) input in the memory image data in multiple video clips, each having a preset length according to the selected template via the interface by following instructions indicated in the interface, wherein the inputted video clips are arranged in preset sequence; (iii) input in the memory audio/text data synchronously with the video clips, respectively, according to the selected template; and (iv) input bibliographical information in the memory, wherein the information is indicated in a first and last video clips which are inserted before and after the video clips arranged in the preset sequence, whereby the short video package comprised of the multiple video clips with the audio/text arranged in sequence is created using the mobile communications device and saved in the memory.

12. The computer-readable medium according to claim 11, wherein the program is further configured to indicate instructions for the user to follow in the interface, so that the device can further indicate instructions for the user to follow in the interface when the user inputs the image data by shooting videos using a camera included in the device, said instructions suggesting shooting close or wide views.

13. The computer-readable medium according to claim 11, wherein the program is further configured to input script and indicate the script in the interface, so that the device can further indicate in the interface script inputted by the user in advance when the user inputs the audio data via the interface.

14. The computer-readable medium according to claim 11, wherein the program is further configured to perform continuous recording of image data for a preset length of time without saving data in the memory except for a preset length of the most recent footage in the memory when the continuous recording is stopped, so that the device can further continuously record image data using a camera included in the device for a preset length of time when the user inputs the image data; and save a preset length of the most recent footage in the memory when either the user stops the continuous recording or the preset length of time for the continuous recording elapses.

15. The computer-readable medium according to claim 11, wherein the device is a smartphone.

16. The computer-readable medium according to claim 11, wherein the preset number of video clips is 4 to 7, each being about 3 seconds to about 5 seconds long.

17. The computer-readable medium according to claim 11, wherein the duration of the video package is about 20 seconds to about 40 seconds.

18. The computer-readable medium according to claim 11, wherein the template is at least one selected from the group consisting of a template for the user speaking, a template for a person other than the user speaking, a template for both the user and another person speaking, a template for on-the-spot reporting, a template for narration, and a template for using subtitles.

19. A method for creating and editing a short video package using a mobile communications device provided with a memory, an interface, and a program stored in the memory and configured to allow a user to select a template for the short video package through the interface among templates whose data are stored in the memory; save in the memory image data as video clips, each having a length according to the selected template; arrange the saved video clips in sequence; save in the memory audio/text data by the user synchronously with the video clips, respectively, according to the selected template; and include bibliographical information saved in the memory in a first and last clips which are inserted before and after the video clips arranged in the sequence, said method comprising:
selecting a template for a short video package by a user through the interface, wherein the total duration of the short video package is preset;
inputting in the memory image data as video clips, wherein each video clip starts and stops by the user via the interface, wherein the inputted video clips are arranged in sequence;
inputting in the memory audio/text data synchronously with the video clips, respectively, according to the selected template; and
inputting bibliographical information in the memory, wherein the information is indicated in a first and last clips which are inserted before and after the video clips arranged in the preset sequence,
whereby the short video package comprised of the multiple video clips with the audio/text arranged in sequence is created using the mobile communications device and saved in the memory.
